(19) United States
(12) Patent Application Publication
(10) Pub. No.: US 2010/0128635 A1
(43) Pub. Date: May 27, 2010

(54) SYSTEM, METHOD AND DEVICE FOR SEGREGATED AND INDEPENDENT COMMAND AND CONTROL OF WIRELESS SERVICE SELECTION, ROUTING, TRANSPORT AND/OR DELIVERY

(76) Inventor: Andrew W. Buffmire, Salt Lake City, UT (US)

Correspondence Address: BLACK LOWE & GRAHAM, PLLC, 701 FIFTH AVENUE, SUITE 4800, SEATTLE, WA, 98104, US

(21) Appl. No.: 12/579,810

(22) Filed: Oct. 15, 2009

Related U.S. Application Data
(60) Provisional application No. 61/105,737, filed on Oct. 15, 2008.
(60) Provisional application No. 61/110,900, filed on Nov. 3, 2008.

(51) Int. Cl. H04L 12/28

(52) U.S. Cl. 370/254

(57) ABSTRACT

Systems and methods of configuring a wireless device are disclosed. An exemplary embodiment selects at least one of a Carrier Network and transport technology and a service provider via at least one of the Control Channel and command and instruction link; separately selects at least one of a transport network and Carrier Network selected from one of the plurality of alternative transport networks or Carrier Networks; and wirelessly communicates voice and data using the selected transport technology and the service provider over the selected transport network and/or Carrier Network

### PRIORITY CLAIM

This application is a Non-Provisional of Provisional Application Ser. No. 61/105,737 (filed on Oct. 15, 2008) and of Provisional Application Ser. No. 61/110,900 (filed on Nov. 3, 2008). Accordingly, the present application claims priority to and the benefit of the filing dates of Provisional Application Ser. No. 61/105,737 and Provisional Application Ser. No. 61/110,900, which are both incorporated by reference herein in their entirety.

### BACKGROUND OF THE INVENTION

A characteristic of the world-wide wireless industry is the development and deployment of competing wireless data and voice transport protocols. These include, for example, deployments of the following technologies by various service providers in the United States and world-wide: Code Division Multiple Access (CDMA), CDMA Evolution Data Optimized (EVDO), EVDO Rev A, Wideband CDMA (WCDMA), Global System for Mobile Communications (GSM) and High-Speed Downlink Packet Access (HSDPA), WiMax and Long-Term Evolution (LTE). All of these platforms provide for the delivery of Voice and Data, a commodity process, albeit over differing protocols, differing discrete systems and differing end-user equipment. Purchasers of the services delivered over these platforms have historically been required to purchase voice and data equipment and terminals uniquely able to acquire only one of these technologies. In addition, the software on the voice and data equipment and terminals has historically been controlled by the carrier providing the equipment and terminals and this software has limited the ability of the purchasers to change networks without, in most instances, changing equipment and/or engaging in an ad-hoc and cumbersome process to change handsets or user devices or change software on existing equipment. As a result changing carriers for the delivery of wireless data and voice services is complicated and cumbersome and, in most instances, requires the change-out of expensive or subsidized equipment.

With the development of increased demand for wireless services and the deployment of more high-speed and high capacity wireless networks the market demand for more flexible and cost-effective wireless services has increased and is increasing. A number of initiatives have been pursued by various industry players in attempting to address this market need. For example, wireless devices have been deployed that will allow for the acquisition of different wireless networks such as, for example, chips to allow laptop computers and other devices to acquire various wireless data networks including, for example, CDMA and HSDPA networks. In addition, software has been deployed on handsets and other terminal devices that allow for the acquisition of signals and networks according to a pre-defined hierarchy such as, for example, a Preferred Roamer List (PRL).

### SUMMARY OF THE INVENTION

Systems and methods of configuring a wireless device are disclosed. An exemplary embodiment selects at least one of a Carrier Network and transport technology and a service provider via at least one of the Control Channel and command and instruction link; separately selects at least one of a transport network and Carrier Network selected from one of the plurality of alternative transport networks or Carrier Networks; and wirelessly communicates voice and data using the selected transport technology and the service provider over the selected transport network and/or Carrier Network.

### BRIEF DESCRIPTION OF THE DRAWINGS

FIG. 1 is an overview of an Integrated Control Device with Segregated Wireless Command Control and Wireless Transport.

FIG. 2 is an overview of an Integrated Control Device with Segregated Wireless Command Control and Wireless Transport integrated with a separate control channel network and with various wireless transport technologies and service providers.

FIG. 3 is a listing of command and control channel system commands, information and services.

FIG. 4 is an overview of a Command and Control Network Device Linked to an End-user Device with a Multi-Network Acquisition Capability (the “Linked Control Device”).

FIG. 5 is an overview of a Linked Control Device integrated with a separate control channel network and with various wireless transport technologies and service providers and wireless networks.

FIG. 6 is a listing of additional command and control channel system commands, information and services that can be addressed or implemented through an Integrated Control Device or a Linked Control Device.

### DETAILED DESCRIPTION

Embodiments provide a terminal device that can acquire multiple broadband carrier telecommunication networks (the “Carrier Network”) and can also acquire a separate command, via a control and instruction channel or link, using a separate chip and wireless service radio, with a separate or common antenna able to acquire and receive communications from a network independent from the networks of existing broadband wireless carriers (the “Control Channel”) and which terminal device also provides for implementation of commands from the Control Channel (the “Integrated Control Device”). Embodiments of the Integrated Control Device allow for commands and instructions to be issued over the Control Channel to a group of devices and/or end-user terminals to determine which technology will be deployed for the transport of voice and/or data, and which Carrier Network is acquired by a defined group of end-user terminal devices and in what order.

Accordingly, this application relates to an Integrated Control Device for a segregated, and independent, wireless command and control over the Control Channel of wireless service selection, wireless transport and wireless communications routing. Embodiments provide for control of the initiation, monitoring, and control of the routing and/or path for the transmission, transport, and delivery of data and/or voice services over a selected Carrier Network. Embodiments provide for, among other things, Carrier Network independent control and delivery of selected services, wireless voice and/or data service technology and transport selection and/or least cost routing over wireless networks and a selected Carrier Network. Additional embodiments provide for the timing of receipt and the timing of action upon commands and/or actions initiated and/or delivered over the Control Channel and the priority of the timing and actions taken and/or commanded.

Examples of an Integrated Control Device embodiment would use, for example, but not be limited to, a multiple technology service chip-set, or the serial linking of separate network components or chip-sets on a common platform, along with the use of an external network and command receipt antenna and chip-set for the Control Channel, such as, for example, a paging network and paging transceiver to receive the paging or independent Control Channel wireless command, or a satellite link antenna and chip, to receive the independent Control Channel wireless command. Embodiments then direct the multiple network chip or the multiple network configured end-user terminal with the Integrated Control Device embodiment to, in turn, acquire a third party network or wireless platform or Carrier Network in the priority and/or order directed, and with the services and capabilities then directed and with the timing and priority then directed. The Control Channel can also be used for the independent and direct delivery of services directly to end-user devices separate from a Carrier Network and/or integrated with a Carrier Network as determined by the controlling party or entity of the Control Channel.

An additional highly desirable capability of such an Integrated Control Device embodiment is the receipt of confirmation that the commands, instructions and/or controls delivered over the Control Channel have been received and acted upon.

Simply put, the deployment of the Integrated Control Device embodiment to control choice of wireless networks for groups of users over a separate Control Channel will, among other things, bring to enterprise and group purchasers of wireless services the same benefits and controls that resulted from the development and rapid market acceptance of long-distance network choice and least-cost purchase of services over long-distance networks.

In operation, an enterprise, and/or an intermediary representing one or more enterprises or group of end-users, will acquire for a group of users a wireless communication terminal containing an Integrated Control Device embodiment. Embodiments will provide for the ability to choose for the Integrated Control Device and the wireless communication terminal a Carrier Network for the delivery of voice and/or data services. The Integrated Control Device will also have the ability to receive through the Control Channel a command and/or instruction that will then determine for the Integrated Control Device the Carrier Network to be used by the Integrated Control Device and/or the wireless communications terminal and the timing and/or priority for acquisition of that Carrier Network. This Integrated Control Device and wireless communications terminal will also have the ability to communicate to the enterprise and/or intermediary that the commands, controls and/or instructions delivered over the Control Channel have been successfully received, acted upon and/or implemented. Additional commands, controls and/or instructions for additional independent services delivered over the Control Channel and/or integrated with the Carrier Network. Upon deployment of the Integrated Control Device incorporated into or integrated with a wireless terminal and the system and platform supporting the Control Channel, the enterprise and/or intermediary will choose the technology and/or Carrier Network for a user or groups of users based upon service and technology availability, geographic area, capacity, capacity by time of day and/or cost and/or other characteristics or elements of the Carrier Network. The choice is then implemented by command to the Integrated Control Device, over the Control Channel. Embodiments then monitor reports of the receipt, action upon and/or subsequent implementation of the controls, commands and instructions delivered over the Control Channel. In some embodiments, the process will be repeated at periodic intervals to optimize the use of wireless transport, its cost and/or its efficiency by the enterprise or by the intermediary.

The following describes in further detail various of the elements and capabilities of embodiments for the segregated, and/or independent command and control of wireless service selection, routing, transport and/or delivery.

As a result of the deployment of an embodiment, an independent telecommunications Control Channel, or link, one or more, or a combination of, all or part of the following is provided:
a. A direct wireless channel, wire line channel, or link to an end-user telecommunications device and/or terminal,
b. A wireless channel, wire line channel, or link to an end-user telecommunications device and/or terminal controlled independent from existing Carrier Networks and wide-area Carrier Network voice and data systems,
c. A wireless channel, wire line channel, Control Channel and/or link able to access an end-user telecommunications device and/or terminal that also has the capability of accessing multiple wireless networks,
d. The ability over the wireless channel, wire line channel, Control Channel and/or link to deliver instructions to the end-user telecommunications device or terminal to choose and cause the implementation of the choice of one or more separate wireless networks for the transport of voice and/or data services,
e. The ability to receive confirmation that the instruction to select and deliver voice and/or data services over the selected wireless transport network or Carrier Network has been received and implemented.

Another set of capabilities and characteristics of the Integrated Control Device embodiments is the ability to directly receive and act upon independent commands and telecommunications over a wireless channel, a wire line channel, a separate link and/or Control Channel. An embodiment may be comprised of one or more, or all of, the following:
a. A receiving antenna and chip set that allows for receipt of independent commands and/or instructions,
b. A microprocessor with the capability of translating and/or transcoding commands and/or instructions including but not limited to commands, controls or instructions delivered over the Control Channel for additional action,
c. Software instructions for receiving and acting upon independent commands and/or instructions received,
d. One or more send and receive antenna and chip sets able to select and communicate with the Control Channel and separately communicate with the Carrier Network, apart from the Control Channel,
e. A microcontroller interface between the Integrated Control Device and the Carrier Network acquisition chip-set in a wireless end-user terminal and/or equipment,
f. The software program between the Integrated Control Device embodiment and the Carrier Network access chip-set and/or antenna in a wireless end-user device,
g. The microcontroller and integrated software program between the Integrated Control Device embodiment and the Carrier Network access chip-set in a wireless end-user terminal and/or equipment,
h. The ability to deliver voice and/or data for transport over the selected Carrier Network.

The Integrated Control Device embodiment for providing independent command, control and instructions over end-user wireless terminals and/or devices including but not limited to command, control and instructions over the Control Channel is comprised of one or more, or all of, the following:
a. The deployment and integrated system implementation of a server separate from the wireless carrier transport networks for command and control of the Integrated Control Device embodiment independent of the Carrier Networks,
b. A data-base customer information, usage and/or data repository independent from the Carrier Networks, yet integrated for wireless transport service provisioning over the Carrier Networks,
c. The method and system for collecting data over or separate from the Control Channel and sending instructions based upon that data in connection with an individual, or groups of individual end-users, over the Control Channel,
d. The method and system for reporting of command and service implementation changes over the Control Channel, or, through the signaling channels such as IS-41, SS7, MAP Link, ENUM, Internet Protocol and/or others across and from the Carrier Network.

The Integrated Control Device embodiment provides for separate delivery of commands to a wireless device through a Control Channel. Embodiments provide for one or more or all of the following capabilities:
a. Choice of wireless voice and/or data transport technologies, network and service provider transport and/or Carrier Network,
b. Choice of least cost routing over wireless transport networks and/or a Carrier Network,
c. Choice of the wireless internet browser to be used as the browser (default or ad-hoc) for third party wireless networks and wireless transport services including but not limited to over a Carrier Network,
d. Commands, controls or instructions over the Control Channel for the delivery of end-user equipment location information and/or location-based data-base related services directly or over a Carrier Network or otherwise,
e. The confirmation of Carrier Network service implementation and/or completion, and the operational functioning of Carrier Network service delivery,
f. Delivery of alerts, ringtones and/or other sound and/or vibration related commands and/or advertising directly to end-user devices over the Control Channel,
g. Data download and/or upload commands, controls, or instructions over the Control Channel or otherwise including, but not limited to, choice of Carrier Network and/or time of day for the data downloads and/or uploads,
h. Access by software developers and/or end-user customers through application programming interfaces (APIs) to the server and system integrated with and/or controlling the Control Channel and/or the data, information and/or commands to be delivered and/or acted upon over the Control Channel,
i. Signals and/or commands over the Control Channel to wake-up or turn-on the terminal and/or end-user communications device and to then commence a pre-determined action that may include initiating access to a Carrier Network,
j. Such other access and capability as may be determined by the controller of the independent Control Channel and such embodiments as may be technically capable of being provided over that Control Channels and related system, method and device now and in the future.

In summary, what is disclosed herein is a device and system and/or Control Channel for the independent control and delivery of commands and/or instructions, and/or wireless services determination, to wireless end-user devices, terminals and/or equipment. Embodiments provide for choosing the technology, network and/or service provider and/or Carrier Network for the transport of wireless voice and/or data services. Embodiments utilize an independent link or pathway to control the choice of the technology and/or transport network over the Control Channel or otherwise, and provide for an independent verification and/or confirmation of the completion of the network and/or path chosen.

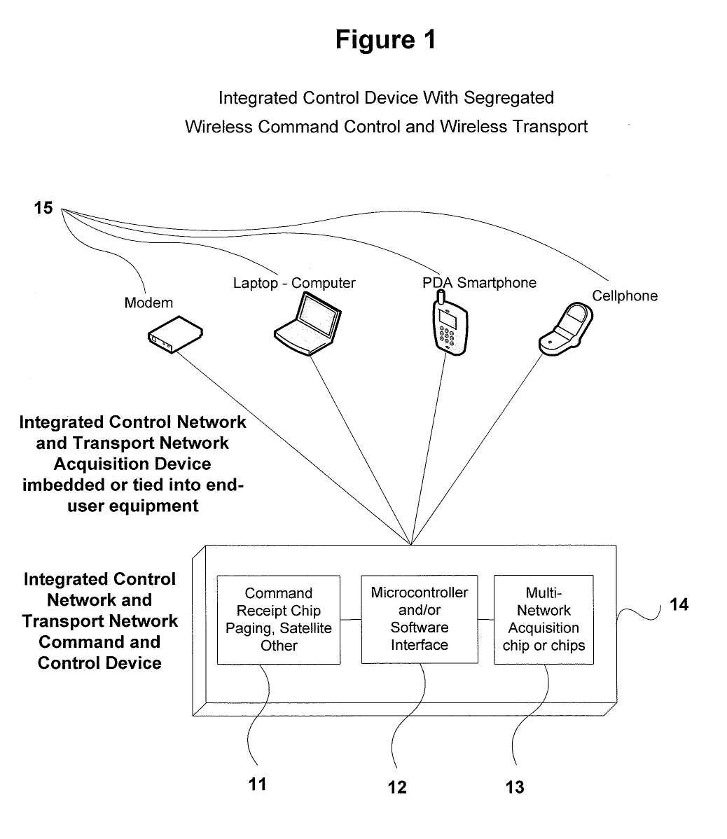

FIG. 1 is an overview of an embodiment of an Integrated Control Device with Segregated Wireless Command Control and Wireless Transport. FIG. 1 provides detail with respect to an integrated control device embodiment that can receive a command on a receiving chip set 11 over a separate Control Channel not controlled by a Carrier Network. Once the command is received, the command is translated through a microcontroller and/or software interface 12 to command the network acquisition chip set 13 to acquire the Carrier Network for wireless voice and data transport. The network acquisition component 13 of the Integrated Control Network and Transport Network Command/Control Device may be comprised of an integrated chip set or it may be comprised of independent chip and transmission components linked to the microcontroller and/or software interface 12. The Integrated Control Network and Transport Network Command/Control Device embodiment is deployed as an integrated unit 14, thus allowing for a uniform, cost-effective and broad deployment of an Integrated Control Device. The Integrated Control Network and Transport Network Command/Control Device embodiment is then imbedded or tied into various end-user components and equipment 15 allowing those devices to be re-directed by a command independent of deployed wireless networks or over the Control Channel to provide for voice and data delivery over an independently selected wireless technology and/or service transport network and/or Carrier Network.

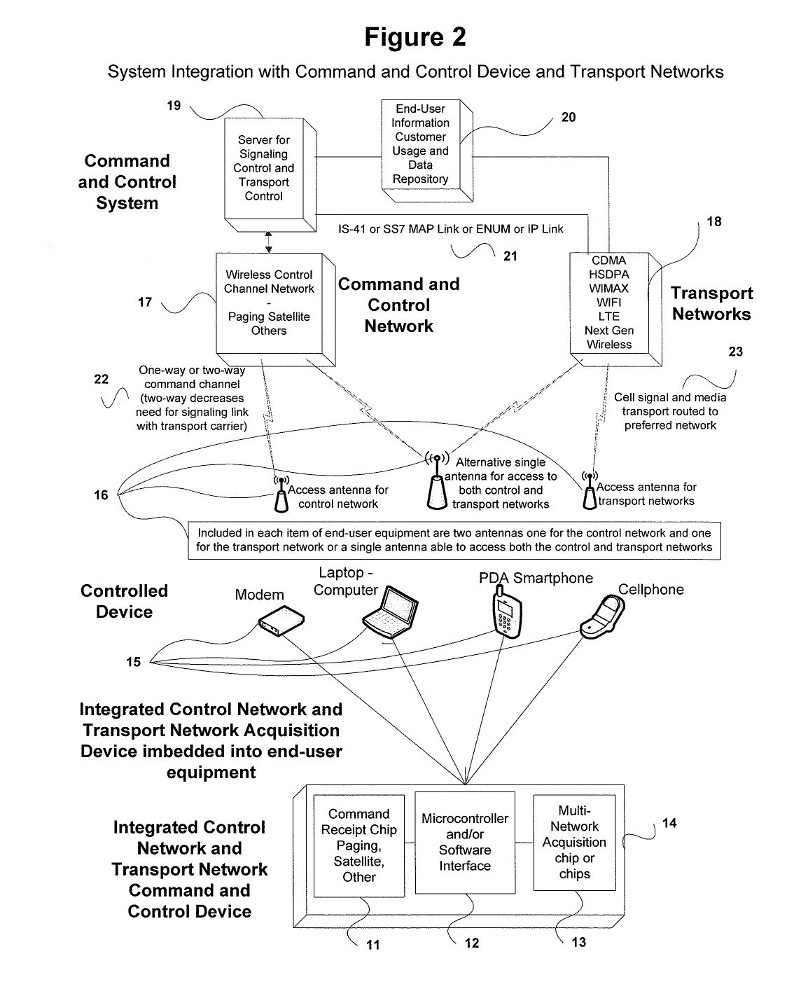

FIG. 2 is an overview of an Integrated Control Device with Segregated Wireless Command Control and Wireless Transport embodiment 14 integrated with a separate control channel network, and integrated with various wireless transport technologies and/or service providers. FIG. 2 shows how the Integrated Control Network and Transport Command/Control Device embodiment 14 is then communicatively integrated into the Carrier Network 18 and a command/control system 17 independent of the Carrier Network 18. It also shows the ability of an end-user device or devices 15 through multiple antennas 16 or a single multi-network capable antenna 16 to acquire both the Control Channel as well as the wireless channel for the Carrier Network 23. The wide-area wireless transport networks may include various high-speed high-bandwidth wireless transport platforms using technologies such as CDMA 2000, CDMA-EVDO, CDMA-EVDO Rev A, WCDMA, HSDPA, WiMax, WiFi, LTE and other and additional next generation high-speed and high-bandwidth wireless data networks 18. FIG. 2 shows a server for control and signaling control of the Control Channel independent of the wireless transport carriers 18 and a data-base for end-user information and customer usage and data independent of the Carrier Network 20. The wireless control channel network is shown as a paging network, a satellite network, or other independent wireless network 17, that provides the ability to deliver commands over the Control Channel or otherwise to the command receipt chip 11 independent of the wide-area wireless transport carriers 18. Also shown are alternative mechanisms for receiving network change, and/or command and control implementation validation, either through a two-way wireless command and control channel 22 or through a signaling channel link over IS-41, SS7 MAP links, ENUM telephone number mapping or directly through an Internet Protocol link and/or other carrier signaling protocol s21.

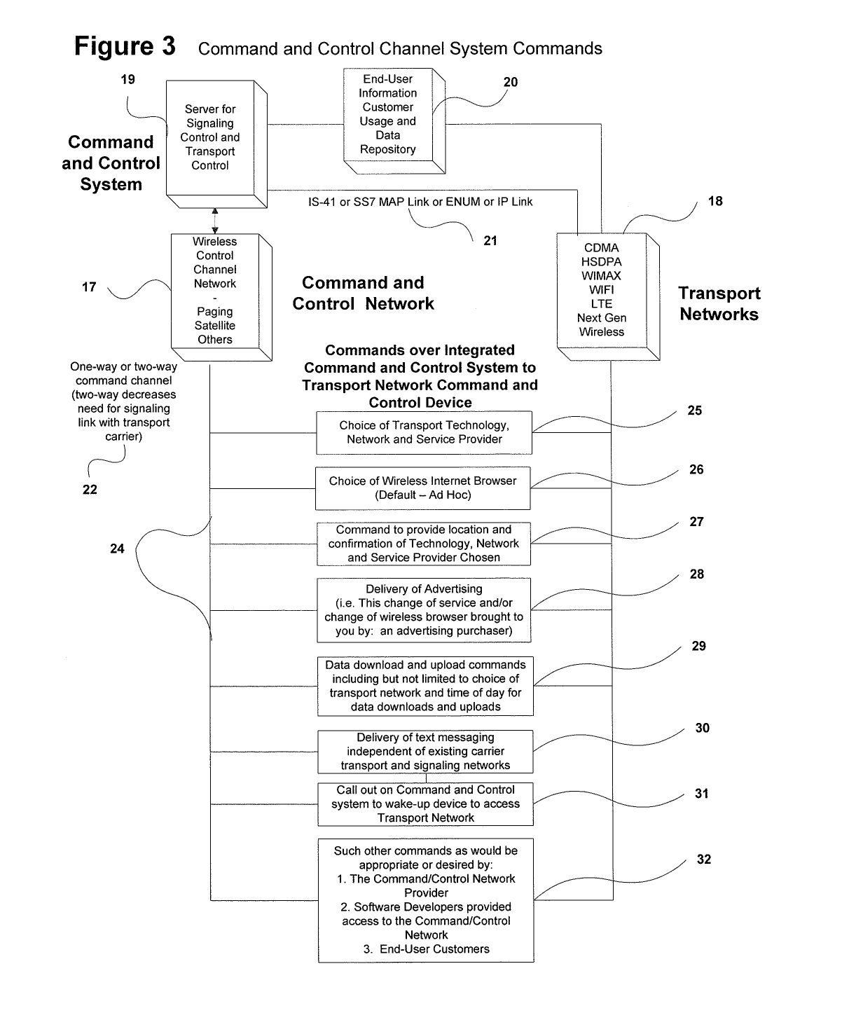

FIG. 3 is a listing of command and control channel system commands, information and/or services that can be delivered over an independent wireless control channel and/or Control Channel to an Integrated Control Network and Transport Network Command and Control Device embodiment 14 that is integrated with both a command and control wireless network and various alternative wireless transport networks and/or Carrier Networks 18. FIG. 3 shows various commands that can be delivered over an independent command and control wireless channel 24. These commands include a choice of transport technology, network and service provider 25, a choice of default or ad-hoc wireless internet browser 26, a command to provide location of the end-user device and confirmation of service platform acquisition to provide for, among other things, delivery of new independently controlled Location Based Services (LBS) 27, a command for the delivery of alerts, ringtones, and/or advertising and/or similar services directly to the end-user device through the command and control channel independent of the wide-area wireless network transport provider 28, a command for data download and/or upload, including but not limited to, choice of network or Carrier Network and/or time of day 29. The delivery of text messaging independent of the Carrier Network 30. The ability to send signals on the command control system and/or Control Channel to wake-up a device and cause it to then access, upon such a wake-up, the selected Carrier Network 31. Such other commands as would be within the scope and capability of the command and control network and/or Control Channel, along with the ability to open this control platform and/or Control Channel for development and/or integration to third party software providers and to end-users 32.

Additional embodiments provide a terminal device (the “Terminal Device”) that can acquire multiple broadband carrier telecommunication networks (the “Carrier Network”) and can also be instructed by a Linked Control Device, via a control and instruction channel or link, using a separate chip and wireless service radio on the Linked Control Device able to acquire and receive communications from a network independent from the networks of existing broadband wireless carriers (the “Control Channel”) and which Linked Control Device also provides for implementation of commands from the Control Channel when physically linked or connected to the Terminal Device and/or linked through a wireless interface such as, for example, a Bluetooth interface. Embodiments of the Linked Control Device allow for commands and instructions to be issued over the Control Channel to the Linked Control Device to then provide instructions and commands to a Terminal Device a group of devices and/or end-user terminals to determine which technology will be deployed for the transport of voice and/or data, and which Carrier Network acquired by a defined group of end-user Terminal Devices and in what order. Accordingly, this application relates to a Linked Control Device for a segregated, and independent, wireless command and control over the Control Channel of wireless service selection, wireless transport and wireless communications routing. Embodiments provide for control of the initiation, monitoring, and control of the routing and/or path for the transmission, transport, and delivery of data and/or voice services over a selected Carrier Network. Embodiments provide for, among other things, Carrier Network independent control and delivery of selected services, wireless voice and/or data service technology and transport selection and/or least cost routing over wireless networks and a selected Carrier Network through commands sent to the Linked Control Device.

Examples of a Linked Control Device embodiment would use, for example, but not limited to linking to a multiple technology service chip-set, or the serial linking of separate network components or chip-sets on a common platform, along with the use of an external network for the Control Channel, such as, for example, a paging network and paging transceiver to receive the paging or independent Control Channel wireless command, or a satellite link antenna and chip, to receive the independent Control Channel wireless command. Embodiments then direct the multiple network chip or the multiple network configured end-user terminal through the Linked Control Device embodiment to, in turn, acquire a third party network or wireless platform or Carrier Network in the priority and/or order directed, and with the services and capabilities then directed. This Control Channel can also be used for the independent and direct delivery through the Linked Control Device of services directly to end-user devices separate from a Carrier Network and/or integrated with a Carrier Network as determined by the controlling party or entity of the Control Channel.

An additional highly desirable capability of such a Linked Control Device embodiment is the receipt of confirmation that the commands, instructions and/or controls delivered over the Control Channel have been received and acted upon.

Simply put, the deployment of the Linked Control Device embodiment to control choice of wireless networks for groups of users over a separate Control Channel will, among other things, bring to enterprise and group purchasers of wireless services the same benefits and controls that resulted from the development and rapid market acceptance of long-distance network choice and least-cost purchase of services over long-distance networks.

In operation, an enterprise, and/or an intermediary representing one or more enterprises or group of end-users, will acquire for a group of users a Terminal Device containing a multi-network acquisition capability along with the capability of connecting to and receiving commands from the Linked Control Device embodiment. Embodiments will provide for the ability to choose for the Terminal Device a Carrier Network for the delivery of voice and/or data services. The Linked Control Device will also have the ability to receive through the Control Channel a command and/or instruction that will then determine for the Linked Control Device the Carrier Network to be used by the Terminal Device. This Linked Control Device along with the Terminal Device will also have the ability to communicate to the enterprise and/or intermediary that the commands, controls and/or instructions delivered over the Command Channel have been successfully received, acted upon and/or implemented. This may include commands, controls and/or instructions for additional independent services delivered over the Command Channel and/or integrated with the Carrier Network. Upon deployment and linking of the Linked Control Device into or integrated with the Terminal Device and the system and platform supporting the Control Channel, the enterprise and/or intermediary will choose the technology and/or Carrier Network for a user or groups of users based upon service and technology availability, geographic area, capacity, capacity by time of day and/or cost and/or other characteristics or elements of the Carrier Network. The Linked Control Device linked to the Terminal Device will then instruct the Terminal Device to implement the command received by the Linked Control Device over the Control Channel. Embodiments then monitor reports of the receipt, action upon and/or subsequent implementation of the controls, commands and instructions delivered over the Control Channel. In some embodiments, the process will be repeated at periodic intervals to optimize the use of wireless transport and its cost by the enterprise or by the intermediary.

The following describes in further detail various of the elements and capabilities of embodiments for the segregated, and/or the independent command and control of wireless service selection, routing, transport and/or delivery.

As a result of the deployment of an embodiment of an independent telecommunications Control Channel, or link, one or more, or a combination of, all or part of the following is provided:
a. A direct wireless channel, wire line channel, or link to a Linked Control Device that connects to or is subsequently connected to a Terminal Device,
b. A wireless channel, wire line channel, or link to a Linked Control Device independent from existing Carrier Network and wide-area network voice and data systems,
c. A wireless channel, wire line channel, Control Channel and/or link able to access a Linked Control Device that is linked directly or later to a Terminal Device that has the capability of accessing multiple wireless networks,
d. The ability over the wireless channel, wire line channel, Control Channel and/or link to deliver instructions to the Linked Control Device linked directly or later to the Terminal Device to choose and cause the implementation of the choice of separate wireless networks for the transport of voice and/or data services,
e. The ability to receive confirmation that the instruction to select and deliver voice and/or data services over the selected wireless transport network or Carrier Network has been received and implemented.

Another set of capabilities and characteristics of the Linked Control Device embodiments is the ability to directly receive and act upon independent commands and telecommunications over a wireless channel, wire line channel, link and/or Control Channel. An embodiment may be comprised of one or more, or all of, the following:
a. A receiving antenna and chip set that allows for receipt of independent commands and/or instructions,
b. A microprocessor with the capability of translating received commands and/or instructions including but not limited to commands, controls or instructions delivered over the Control Channel for additional action,
c. Software instructions for receiving and acting upon independent commands and/or instructions received,
d. A send and receive antenna and chip set in the Terminal Device able to select and communicate with the Linked Control Device and separately communicate with the Carrier Network, apart from the Control Channel,
e. A USB port, SD Card, microcontroller, wireless interface and/or other interface between the Linked Control Device and the Terminal Device,
f. The software program between the Linked Control Device embodiment and the Terminal Device,
g. The USB port, SD Card, microcontroller wireless interface and/or other interface and integrated software program between the Linked Control Device embodiment and the Terminal Device,
h. The ability to instruct and have the instructions acted upon for the delivery of voice and/or data for transport over the selected Carrier Network.

The Linked Control Device embodiment for providing independent command, control and instructions to the Terminal Device including but not limited to command, control and instructions received over the Control Channel is comprised of one or more, or all of, the following:
a. The deployment and integrated system implementation of a server separate from the wireless carrier transport networks for command and control of the Linked Control Device embodiment independent of the Carrier Networks,
b. A data-base customer information, usage and/or data repository independent from the Carrier Networks, yet integrated for wireless transport service provisioning over the Carrier Networks,
c. The method and system for collecting data over or separate from the Control Channel and sending instructions based upon that data in connection with an individual, or groups of individual end-users, over the Control Channel,
d. The method and system for reporting of command and service implementation changes over the Control Channel, or, through the signaling channels across and from the Carrier Network.

The Linked Control Device embodiment provides for separate delivery of commands to a Terminal Device received from a Control Channel and delivered from the Linked Control Device to the Terminal Device through a USB port, SD Card, Microcontroller, wireless interface and/or other interface. Embodiments provide for one or more or all of the following capabilities:
a. Choice of wireless voice and/or data transport technologies, network and service provider transport and/or Carrier Network,
b. Choice of least cost routing over wireless transport networks and/or a Carrier Network,
c. Choice of the wireless internet browser to be used as the browser (default or ad-hoc) for third party wireless networks and wireless transport services including but not limited to over a Carrier Network,
d. Commands, controls or instructions over the Control Channel for the delivery of end-user equipment location information and/or location based services directly or over a Carrier Network or otherwise,
e. The confirmation of Carrier Network service implementation and/or completion, and the operational functioning of Carrier Network service delivery,
f. Delivery of alerts, ringtones and/or other sound and/or vibration related commands and/or advertising directly to end-user devices over the Control Channel,
g. Data download and/or upload commands, controls, or instructions over the Control Channel or otherwise including, but not limited to, choice of Carrier Network and/or time of day for the data downloads and/or uploads,
h. Access by software developers and/or end-user customers through application programming interfaces (APIs) to the server and system integrated with and/or controlling the Control Channel,
i. Signals and/or commands over the Control Channel to wake-up or turn-on the terminal and/or end-user communications device and to then commence a pre-determined action that may include initiating access to a Carrier Network,
j. Such other access and capability as may be determined by the controller of the independent Control Channel and such embodiments as may be technically capable of being provided over that Control Channels and related system, method and device now and in the future.

In summary, what is disclosed herein is an additional device and system and/or Control Channel for the independent control and delivery of commands and/or instructions, and/or wireless services determination, to wireless end-user devices, terminals and/or equipment. Embodiments provide for choosing the technology, network and/or service provider and/or Carrier Network for the transport of wireless voice and/or data services. Embodiments utilize an independent link or pathway to control the choice of the technology and/or transport network over the Control Channel or otherwise, and provide for an independent verification and/or confirmation of the completion of the network and/or path chosen.

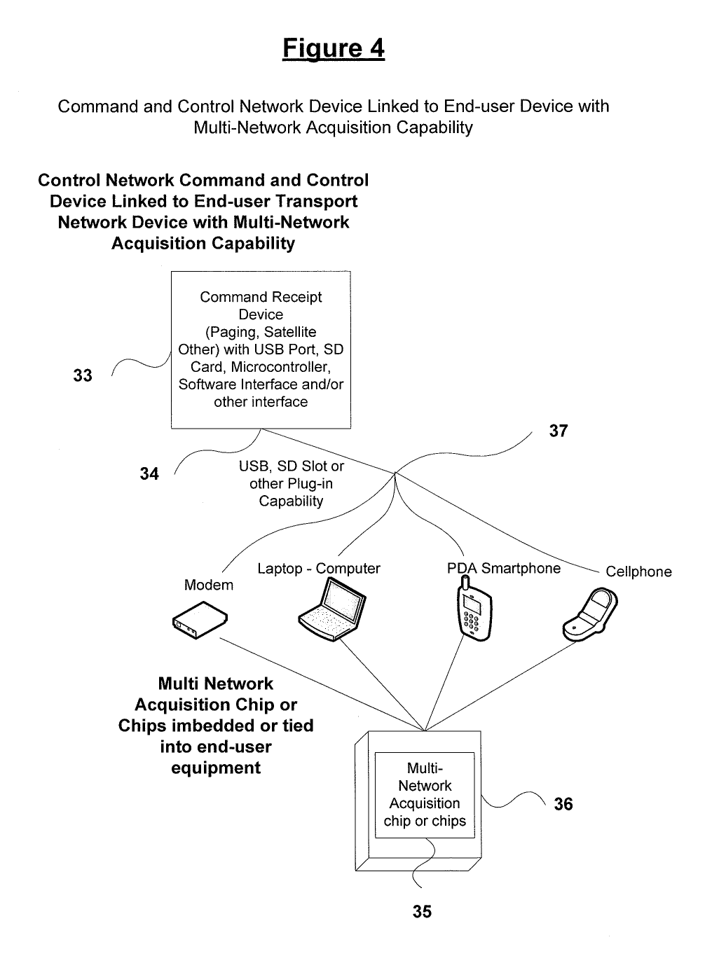

FIG. 4 is an overview of an embodiment of a Linked Control Device with Segregated Wireless Command Control and Wireless Transport. FIG. 4 provides detail with respect to a linked control device embodiment that can receive a command on a receiving Linked Control Device 33 over a separate Control Channel not controlled by a Carrier Network. Once the command is received, the command is translated through a USB Port, SD Card, microcontroller, software, wireless interface (such as Bluetooth) and/or other interface 34 to command the Terminal Device 37 to acquire the Carrier Network for wireless voice and data transport. The Linked Control Device and Terminal Device may be deployed as separate units thus allowing for a flexible deployment of the command and control capability allowing these devices when linked to re-direct the Terminal Device by a command independent of deployed wireless networks and/or over the Control Channel to provide for voice and data delivery over an independently selected wireless technology and/or service transport network and/or Carrier Network.

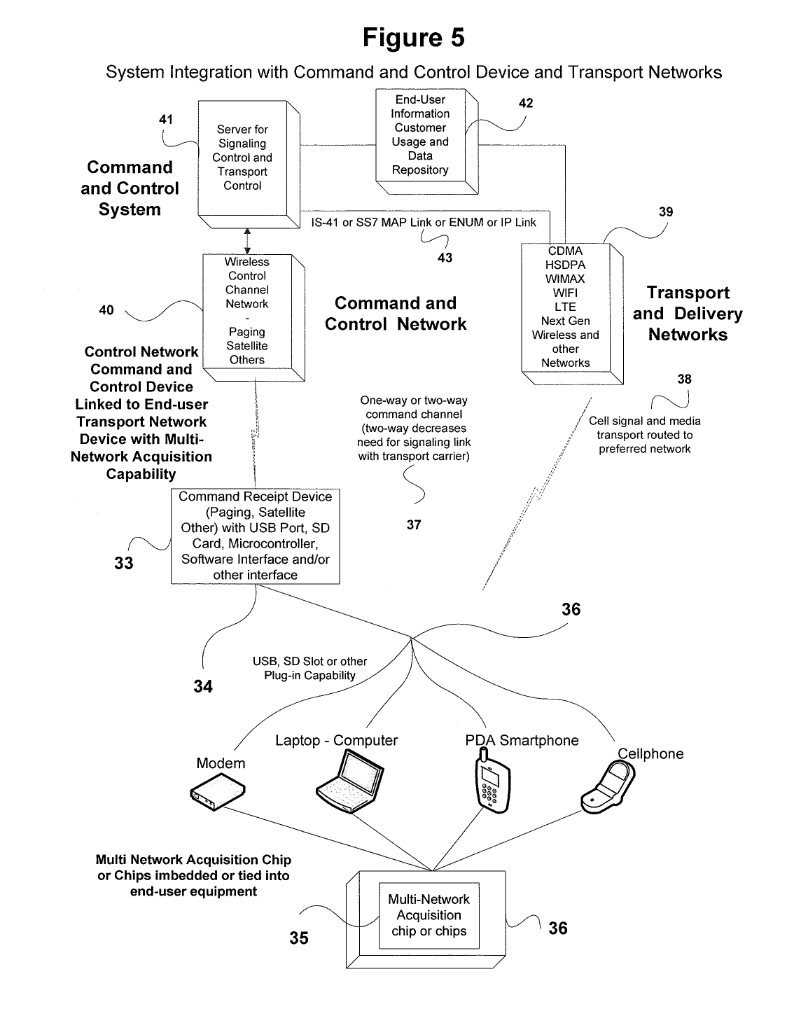

FIG. 5 is an overview of a Linked Control Device 33 linked with a Terminal Device 36 and with the wireless Control Channel 40. FIG. 5 shows how the Terminal Device is then communicatively integrated into the Carrier Network 39 and a command/control system 41 independent of the Carrier Network 39. It also shows the ability of a the Linked Control Device and the Terminal Device to link while each device acquires respectively for the Linked Control Device 33 the Control Channel 40 and for the Terminal Device 36 the Transport Network 39. The wide-area wireless transport networks may include various high-speed high-bandwidth wireless transport platforms using technologies such as CDMA 2000, CDMA-EVDO, CDMA-EVDO Rev A, WCDMA, HSDPA, WiMax, WiFi, LTE and other and additional next generation high-speed and high-bandwidth wireless data networks such as Forward Link Only (FLO) networks 39. FIG. 5 shows a server for control and signaling control of the Control Channel independent of the wireless transport carriers 39 and a data-base for end-user information and customer usage and data independent of the Carrier Network 42. The wireless control channel network is shown as a paging network, a satellite network, or other independent wireless network 40, that provides the ability to deliver commands over the Control Channel or otherwise to the Linked Control Device 33 independent of the wide-area wireless transport carriers or other wireless networks 39. Also shown are alternative mechanisms for receiving network change, and/or command and control implementation validation, either through a two-way wireless command and control channel 37 or through a signaling channel link over IS-41, SS7 MAP links, ENUM telephone number mapping or directly through an Internet Protocol link 43.

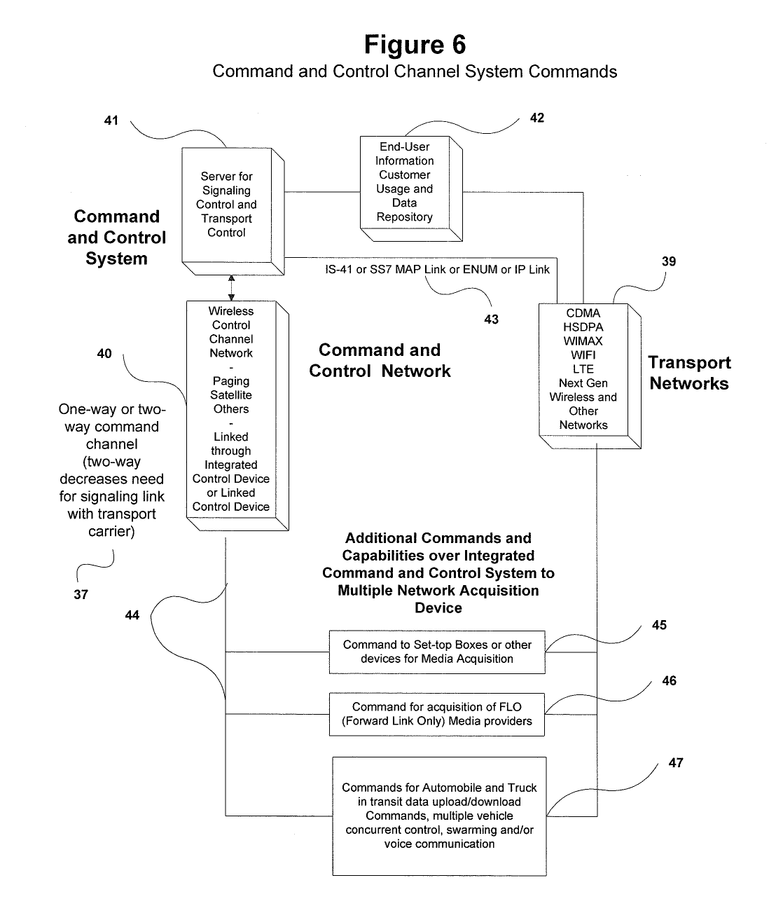

FIG. 6 is a listing of additional command and control channel system commands, information and/or services that can be delivered over an independent wireless control channel and/or Control Channel to an Integrated Control Network and Transport Network Command and Control Device embodiment or to a Linked Control Device and Terminal Device 44 that is integrated with both a command and control wireless network and various alternative wireless transport networks and/or Carrier Networks 39. FIG. 6 shows additional commands that can be delivered over an independent command and control wireless channel 40 using an Integrated Control Device or a Linked Control Device. These additional commands include a command to a set-top or other device for voice, data and/or media acquisition and/or transport 45, a command for acquisition and receipt of media from FLO (Forward Link Only) media providers 46, commands for automobile and/or truck in transit data downloads and uploads across chosen networks and/or for multiple network concurrent control, swarming control and/or other voice and data communication 47.

The scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for configuring a wireless device, comprising:
a receiving antenna and chip set configured to receive at least one of independent commands, controls and instructions over a Control Channel;
a microprocessor coupled to the receiving antenna and configured to translate received at least one of commands, controls and instructions for additional action;
a memory with a plurality of software instructions executed by the microprocessor for receiving and acting upon the received at least one of commands, controls and instructions; and
a send and receive antenna and chip set configured to select and communicate with a command and instruction link, and configured to communicate with a plurality of alternative wireless data and voice transport networks and Carrier Networks apart from at least one of the command and instruction link and Control Channel.

2. The system of claim 1, wherein a selection of at least one of a transport technology and a service provider and Carrier Network determined via the at least one of command and instruction link and Control Channel is separate from a selection of a Carrier Network selected from one of the plurality of alternative Carrier Networks.

3. A method for configuring a wireless device, comprising:
selecting at least one of a Carrier Network and transport technology and a service provider via at least one of the Control Channel and command and instruction link;
separately selecting at least one of a transport network and Carrier Network selected from one of the plurality of alternative transport networks or Carrier Networks; and
wirelessly communicating voice and data using the selected transport technology and the service provider over the selected transport network and/or Carrier Network.

4. A device able to receive commands and instructions over the Control Channel and then to execute those commands and instructions by linking the device to a Terminal Device through a at least one of USB port, SD Card, Microcontroller, software, wireless interface, and other interface.
